(19) United States
(12) Patent Application Publication
(10) Pub. No.: US 2021/0107359 A1
(43) Pub. Date: Apr. 15, 2021

(54) DRIVER ASSIST APPARATUS

(71) Applicant: Toyota Jidosha Kabushiki Kaisha, Toyota-shi (JP)

(72) Inventors: Toshihiro Takagi, Nisshin-shi (JP); Yasutaka Matsunaga, Nisshin-shi (JP); Ryo Izumi, Toyota-shi (JP)

(73) Assignee: Toyota Jidosha Kabushiki Kaisha, Toyota-shi, (JP)

(21) Appl. No.: 17/066,900

(22) Filed: Oct. 9, 2020

(30) Foreign Application Priority Data
Oct. 11, 2019 (JP) 2019-187944

(51) Int. Cl. B60K 35/00

(52) U.S. Cl. CPC B60K 35/00; B60K 2370/152; B60K 2370/1434; B60K 2370/175; B60K 2370/176; B60K 2370/178; B60K 2370/1868; B60K 2370/122

(57) ABSTRACT

The driver assist apparatus comprises an ECU. When a customization button is touched while the ECU is displaying a surrounding monitoring screen that includes a surrounding image and the customization button, the ECU starts displaying a customization screen in place of the surrounding monitoring screen. When a predetermined condition is satisfied while the ECU is displaying the customization screen, the ECU starts displaying an alert screen in place of the customization screen.

### BACKGROUND

### Field

The present disclosure relates to a driver assist apparatus configured to assist the driver to monitor surroundings of a vehicle.

### Description of the Related Art

A driver assist apparatus (hereinafter, referred to as a “conventional apparatus”) of the type described above is configured to obtain a captured image (surrounding image). The captured image is an image of the surrounding area of the vehicle and is acquired by on-board camera devices. The conventional apparatus is configured to display, on a display unit, a surrounding monitoring screen that includes the captured image, in order to assist the driver to monitor the surroundings of the vehicle.

Meanwhile, a navigation system disclosed in Japanese Patent Application Laid-Open (kokai) No. 2005-351868 is configured to display, on the display unit, an operation screen that allows the driver to change/set various conditions for navigation.

Similarly to the above navigation system, a driver assist apparatus of the type described above may be configured to display, on the display unit, an operation screen (hereinafter, referred to as a “customization screen”) that allows the driver to change/customize settings of systems that provide various driver assist functions. One of examples of the driver assist functions is a parking assist function.

The conventional apparatus stops displaying the surrounding monitoring screen when the customization screen is requested/required to be displayed, and starts displaying the customization screen, instead. Therefore, the driver cannot see/watch the surrounding monitoring screen while the customization screen is being displayed. This may degrade the ability of assisting the driver to monitor the surroundings of the vehicle. In other words, if this happens, it is not easy for the driver to recognize/notice a change in a state of the surrounding area of the vehicle from the screen. The change in the state of the surrounding area of the vehicle may occur, for instance, when a moving object or a pedestrian is approaching the vehicle.

### SUMMARY

The present disclosure is made to cope with the above problem. In other words, one of objects of the present disclosure is to provide a driver assist apparatus that can decrease a possibility that the ability of assisting the driver to monitor the surroundings of the vehicle is degraded. Hereinafter, the driver assist apparatus according to the present disclosure may be referred to as a “present disclosed driver assist apparatus”.

The present disclosed driver assist apparatus is installed on a vehicle (100), and comprises:

a surrounding monitor sensor device (30, 40, 50) configured to capture an image of a surrounding area of the vehicle to obtain image information and object information regarding an object that is present around the vehicle;

a touch panel (60) configured to be capable of displaying images; and

a control unit (90) configured to be capable of changing the images displayed on the touch panel.

The control unit is configured to:
display, on the touch panel, a surrounding monitoring screen (G3) that includes a surrounding image of the surrounding area of the vehicle when a predetermined surrounding monitoring screen display condition is satisfied, the surrounding image being generated based on the image information;
display, on the touch panel, a customization screen (e.g., G4a) in place of the surrounding monitoring screen (e.g., step 1220) when an operation to a customization button is detected (e.g., step 1215) while the surrounding monitoring screen is being displayed (e.g., step 1210), the customization screen being a screen that is operated to change operation conditions of driving assist functions that the control unit provides for the vehicle; and
display, on the touch panel, an alert screen (G5) including the surrounding image and an alert image (e.g., step 1330) for notifying a driver of the vehicle of a presence of a target alert object that is the object that the driver should pay attention to, in place of the customization screen, if the target alert object is detected based on the object information (e.g., step 1315: Yes) even when the customization screen is being displayed in place of the surrounding monitoring screen (e.g., step 1310).

In some embodiments, the driver assist apparatus is installed on the vehicle (100), and is configured to provide (display) a surrounding monitoring screen to the driver so as to assist the driver to monitor the surroundings of the vehicle.

The driver assist apparatus includes:
a detection device (30, 40, 50), including an imaging device (40) configured to capture an image of the surrounding area of the vehicle to obtain image information, the detection device configured to detect a target object that includes at least one of a stationary object present in the surrounding area of the vehicle and a moving object present in the surrounding area of the vehicle;
a touch panel (60) configured to be capable of displaying images; and
a display control unit/section (control unit 90) configured to produce/generate a surrounding image that is an image of the surrounding area of the vehicle from the obtained image information, and to control a screen displayed on the touch panel (60), the screen including the produced surrounding image.

The display control section (90) is configured to perform (carry out) an alert screen display control to display an alert screen (G5) including the produced surrounding image, in a period where a predetermined condition to be satisfied when the target alert object has been detected is met.

In addition, the display control section (90) is configured to:
switch from a surrounding monitoring screen (G3) including the surrounding image and a customization button (Btc) to a customization screen (G4a) that is an operation screen to adjust operating conditions/states of a predetermined driver assist function that is provided to the vehicle so as to display the customization screen (G4a) (step 1220), when a touch operation is made/performed to the customization button (step 1215: Yes) while the surrounding monitoring screen (G3) is being displayed (step 1210: Yes); and
switch from the customization screen to the alert screen (G5) so as to display the alert screen (step 1330), when the predetermined condition becomes satisfied (step 1315: Yes) while the customization screen is being displayed (step 1310).

According to the present disclosed driver assist apparatus, the customization screen is switched to the alert screen when the target alert object is detected while the customization screen is being displayed, so that the alert screen starts to be displayed in place of the customization screen. In other words, when the predetermined condition is satisfied, the alert screen is displayed in place of the customization screen. Consequently, the present disclosed driver assist apparatus can decrease a possibility that the ability of assisting the driver to monitor the surroundings of the vehicle is degraded.

In some embodiments, the control unit is configured to display, on the touch panel, the customization screen in place of the alert screen when the target alert object is no longer detected while the alert screen is being displayed in place of the customization screen (steps 1410, 1415, and 1420).

In other words, the display control section (90) is configured to display the alert screen in place of the customization screen only while the predetermined condition is satisfied, after the display control section switched from the customization screen to the alert screen (steps 1410, 1415, and 1420).

According to the above embodiment, the customization screen is displayed again when the target alert object is no longer detected while the alert screen is being displayed. Therefore, the above embodiment can not only decrease the possibility that the ability of assisting the driver to monitor the surroundings of the vehicle is degraded, but also improve ease of use with respect to the customization screen.

In some embodiments,

the control unit is configured to:
display the surrounding monitoring screen in such a manner that the surrounding monitoring screen includes the customization button;
detect a touch operation to the customization button as the operation to the customization button, when the vehicle is in a stopped state; and
ignore the touch operation to the customization button so as not to detect the touch operation as the operation to the customization button, when the vehicle is not in the stopped state.

In other words, the customization button is set to a state where the touch operation to the customization button is acceptable when the vehicle is not moving, and the customization button is set to a state where the touch operation to the customization button is not acceptable (or is ignored) when the vehicle is moving.

In some embodiments, the control unit is further configured to, when a moving object approaching (coming closer to) the vehicle is detected as the target alert object, display the alert screen in such a manner that a figure/mark indicating a direction along which the moving object is coming closer to the vehicle.

In other words, the alert object includes the moving object approaching (coming closer to) the vehicle, and the alert screen includes the surrounding image and an object moving direction figure/mark that indicates from which orientation the object is coming closer to the vehicle and that is superimposed on the surrounding image.

According to the above embodiment, the driver/user cannot let the display panel start to display the customization screen when the vehicle is moving (i.e., is not in the stopped state) using the customization button. Therefore, the above embodiment can decrease the possibility that the ability of assisting the driver to monitor the surroundings of the vehicle is degraded, while the vehicle is moving. In addition, the above embodiment detects the moving object that is approaching the vehicle and to which the driver should pay attention, when (in a period where) the vehicle is in the stopped state and the customization screen is being displayed. Therefore, the above embodiment can decrease the possibility that the ability of assisting the driver to monitor the surroundings of the vehicle is degraded, while the vehicle is not moving.

In some embodiments, the control unit is configured to:
provide the vehicle with, as one of the driving assist functions, a parking assist function to assist the driver to park the vehicle;
display, as the surrounding monitoring screen, a parking assist screen to assist the driver to park the vehicle; and
display, as the customization screen, a screen to change operation states of the parking assist function.

In other words, the surrounding monitoring screen may be the parking assist screen that is allowed to be displayed when the parking assist function that the vehicle has is in an effective state (step 1205: Yes), and

the customization screen is the operation screen used to change the operating states of the parking assist function.

The above embodiment can decrease the possibility that the ability of assisting the driver to monitor the surroundings of the vehicle is degraded, while the parking assist function is working.

In some embodiments,

the control unit is configured to:
provide the vehicle with, as one of the driving assist functions, a panoramic-view monitoring function to display, as the surrounding monitoring screen, a panoramic-view monitor screen including a bird's-eye-view of the vehicle, when a speed of the vehicle is equal to or lower than a predetermined speed threshold; and
display, as the customization screen, a screen to change operation states of the panoramic-view monitoring function.

In other words, the surrounding monitoring screen may be the panoramic-view monitor screen that is allowed to be displayed when the panoramic-view monitoring function that the vehicle has is in an effective state (step 1505: Yes), and

the customization screen is the operation screen used to change the operating states of the panoramic-view monitoring function.

The above embodiment can decrease the possibility that the ability of assisting the driver to monitor the surroundings of the vehicle is degraded, while the panoramic-view monitoring function is working.

Notably, in the above description, in order to facilitate understanding of the present disclosure, the constituent elements or parameters of the disclosure (embodiments) which will be described later are accompanied by parenthesized names and/or symbols which are used to describe the embodiments. However, the constituent elements or parameters of the present disclosure are not limited to those in the embodiments defined by the names and/or the symbols. Other objects, other features, and attendant advantages of the present disclosure will be readily appreciated from the following description of the embodiment of the disclosure which is made with reference to the accompanying drawings.

### BRIEF DESCRIPTION OF THE DRAWINGS

FIG. 1 is a block diagram of a driver assist apparatus according to an embodiment of the present disclosure and a vehicle to which the driver assist apparatus is applied;

FIG. 2 is a figure illustrating positions of sonar sensors and their detection areas;

FIG. 3 is a figure illustrating positions of camera sensors and their imaging areas;

FIG. 4 is a figure illustrating positions of radar sensors;

FIG. 5A shows an example of images displayed on the touch panel screen;

FIG. 5B shows another example of images displayed on the touch panel screen;

FIG. 6 shows another example of images displayed on the touch panel screen;

FIG. 7 shows another example of images displayed on the touch panel screen;

FIG. 8 shows another example of images displayed on the touch panel screen;

FIG. 9 shows another example of images displayed on the touch panel screen;

FIG. 10A shows another example of images displayed on the touch panel screen;

FIG. 10B shows another example of images displayed on the touch panel screen;

FIG. 11 shows another example of images displayed on the touch panel screen;

FIG. 12 is a flowchart representing a routine executed by a CPU of the ECU shown in FIG. 1;

FIG. 13 is a flowchart representing a routine executed by the CPU;

FIG. 14 is a flowchart representing a routine executed by the CPU;

FIG. 15 is a flowchart representing a routine executed by the CPU;

FIG. 16 is a flowchart representing a routine executed by the CPU; and

FIG. 17 is a flowchart representing a routine executed by the CPU.

### DESCRIPTION OF THE PREFERRED EMBODIMENTS

### (Configuration)

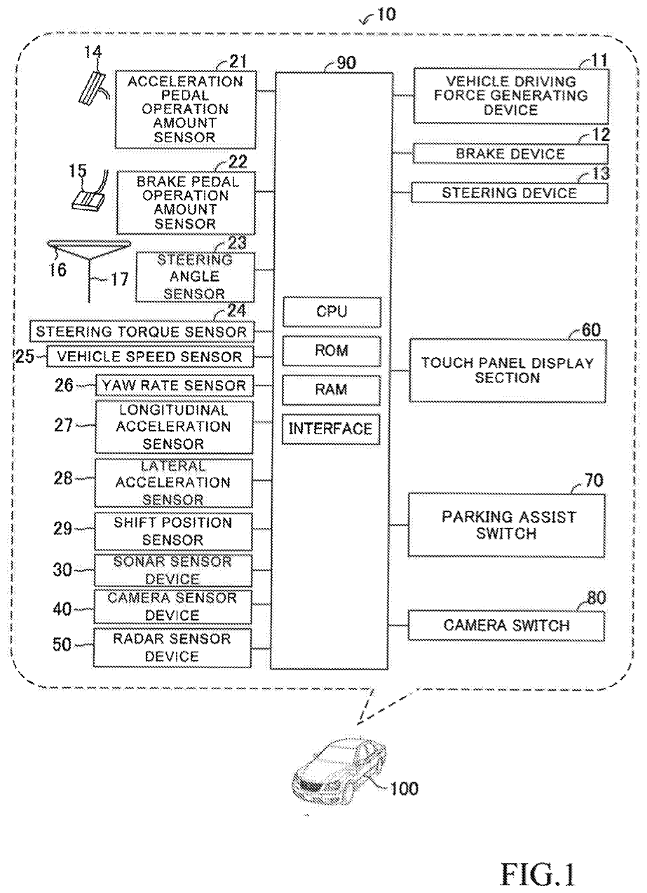

A driver assist apparatus according to an embodiment of the present disclosure will next be described with reference to the drawings. It should be noted that a common reference is given to the same or the corresponding parts/elements throughout the drawings. FIG. 1 illustrates the driver assist apparatus 10 and the vehicle 100 to which the driver assist apparatus 10 is applied.

As shown in FIG. 1, the driver assist apparatus 10 includes an ECU 90. The ECU is an abbreviation of an “Electronic Control Unit” which is a controller. The ECU 90 includes, as a main component, a microcomputer having a CPU, a ROM, a RAM, a nonvolatile memory, and an interface I/F. The CPU achieves various functions through executing instructions, programs, or routines, stored in the ROM. The ECU 90 may be separated into a plurality of ECUs that cooperate with each other.

The vehicle 100 is equipped with a vehicle driving force generating device 11, a brake device 12, and a steering device 13. The vehicle driving force generating device 11 is configured to generate a driving force to drive the vehicle 100 and to transmit the driving force to drive wheels of the vehicle 100. The vehicle driving force generating device 11 includes, for instance, an internal combustion engine, and a motor. The brake device 12 is configured to apply a brake force to wheels of the vehicle 100. The steering device 13 is configured to generate a steering torque to steer the vehicle 100 and to apply the steering torque to steered wheels of the vehicle 100.

The ECU 90 is electrically connected with the vehicle driving force generating device 11, the brake device 12, and the steering device 13. The ECU 90 is configured to control the vehicle driving force generating device 11 so as to control the driving force applied to the drive wheels. The ECU 90 is configured to control the brake device 12 so as to control the brake force applied to the wheels. The ECU 90 is configured to control the steering device 13 so as to control the steering torque applied to the steered wheels.

The driver assist apparatus 10 comprises an acceleration pedal operation amount sensor 21, a brake pedal operation amount sensor 22, a steering angle sensor 23, a steering torque sensor 24, a vehicle speed sensor 25, a yaw rate sensor 26, a longitudinal acceleration sensor 27, a lateral acceleration sensor 28, a shift position sensor 29, a sonar sensor device 30, a camera sensor device 40, a radar sensor device 50, a touch panel display section 60, a parking assist switch 70, and a camera switch 80. The sonar sensor device 30, the camera sensor device 40, and the radar sensor device 50 may be collectively referred to as a “surrounding monitor sensor device”.

The acceleration pedal operation amount sensor 21 is electrically connected with the ECU 90 and is configured to output a signal indicative of an acceleration pedal operation amount AP. The ECU 90 is configured to obtain the acceleration pedal operation amount AP based on the signal of the acceleration pedal operation amount sensor 21. The ECU 90 is configured to control the vehicle driving force generating device 11 based on the obtained acceleration pedal operation amount AP in such a manner that the driving force applied to the drive wheels is varied based on the obtained acceleration pedal operation amount AP.

The brake pedal operation amount sensor 22 is electrically connected with the ECU 90 and is configured to output a signal indicative of a brake pedal operation amount BP. The ECU 90 is configured to obtain the brake pedal operation amount BP based on the signal of the brake pedal operation amount sensor 22. The ECU 90 is configured to control the brake device 12 based on the obtained brake pedal operation amount BP in such a manner that the brake force applied to the wheels of the vehicle 100 is varied based on the obtained brake pedal operation amount BP.

The steering angle sensor 23 is electrically connected with the ECU 90 and is configured to output a signal indicative of a rotation angle θst with respect to a neutral position of a steering wheel 16. The ECU 90 is configured to obtain the rotation angle θst as a steering angle θst, based on the signal of the steering angle sensor 23.

The steering torque sensor 24 is electrically connected with the ECU 90 and is configured to output a signal indicative of a torque TQst input by the driver (user) to the steering shaft 17. The ECU 90 is configured to obtain the torque TQst as a steering torque TQst based on the signal of the steering torque sensor 24.

The ECU 90 is configured to control the steering device 13 based on the obtained steering angle θst and the obtained steering torque TQst in such a manner that the steering torque applied to the steered wheels of the vehicle 100 is varied based on the obtained steering angle θst and the obtained steering torque TQst.

The vehicle speed sensor 25 is electrically connected with the ECU 90 and is configured to output a signal indicative of a rotational speed Vrot of each of the wheels of the vehicle 100. The ECU 90 is configured to obtain the rotational speed Vrot of each of the wheels based on each of the signals of the vehicle speed sensors 25, and to obtain a vehicle speed SPD which is a running speed of the vehicle 100 based on the obtained rotational speed Vrot of each of the wheels.

The yaw rate sensor 26 is electrically connected with the ECU 90 and is configured to output a signal indicative of a yaw rate YR of the vehicle 100. The ECU 90 is configured to obtain the yaw rate YR of the vehicle 100 based on the signal of the yaw rate sensor 26.

The longitudinal acceleration sensor 27 is electrically connected with the ECU 90 and is configured to output a signal indicative of a longitudinal acceleration Gx of the vehicle 100. The ECU 90 is configured to obtain the longitudinal acceleration Gx of the vehicle 100 based on the signal of the longitudinal acceleration sensor 27.

The lateral acceleration sensor 28 is electrically connected with the ECU 90 and is configured to output a signal indicative of a lateral acceleration Gy of the vehicle 100. The ECU 90 is configured to obtain the lateral acceleration Gy of the vehicle 100 based on the signal of the lateral acceleration sensor 28.

The shift position sensor 29 is electrically connected with the ECU 90 and is configured to output a signal indicative of a position of an unillustrated shift lever. The position of the shift lever is a parking position (P), a forward position (D), or a reverse position (R). The ECU 90 is configured to obtain the shift lever position based on the signal of the shift position sensor 29, and to control an unillustrated transmission and/or an unillustrated drive direction changing mechanism, based on the obtained shift lever position. Namely, the ECU 90 is configured to perform a shift control. In addition, the ECU 90 is configured to be capable of controlling the transmission and/or the drive direction changing mechanism as well as the position of the shift lever, regardless of the user's operation to the shift lever.

The sonar sensor device 30 comprises a first clearance sonar 301 to a twelfth clearance sonar 312. Hereinafter, the first clearance sonar 301 to the twelfth clearance sonar 312 may sometimes be collectively referred to as clearance sonars 313, as appropriate.

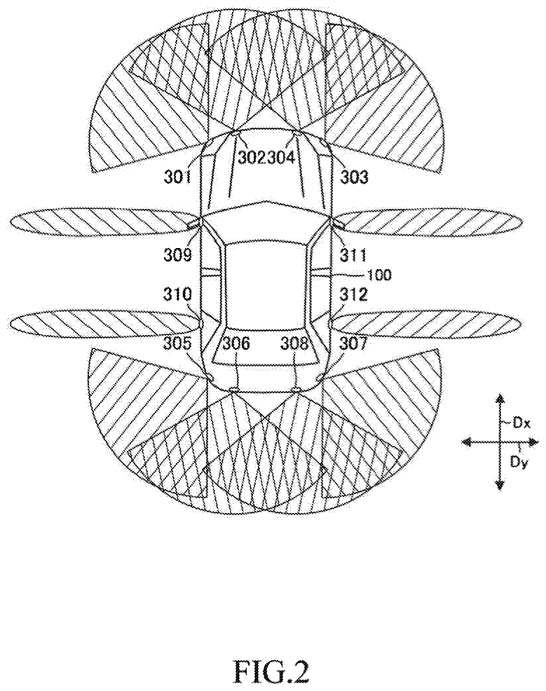

As shown in FIG. 2, the first clearance sonar 301 is fixed to the vehicle 100 so as to radiate ultrasonic wave along a front left direction from a front left end part of the vehicle 100.

The second clearance sonar 302 is fixed to the vehicle 100 so as to radiate ultrasonic wave along a front direction from a front end on the left side of the vehicle 100.

The third clearance sonar 303 is fixed to the vehicle 100 so as to radiate ultrasonic wave along a front right direction from a front right end part of the vehicle 100.

The fourth clearance sonar 304 is fixed to the vehicle 100 so as to radiate ultrasonic wave along the front direction from the front end on the right side of the vehicle 100.

The fifth clearance sonar 305 is fixed to the vehicle 100 so as to radiate ultrasonic wave along a rear left direction from a rear left end part of the vehicle 100.

The sixth clearance sonar 306 is fixed to the vehicle 100 so as to radiate ultrasonic wave along a rear direction from a rear end on the left side of the vehicle 100.

The seventh clearance sonar 307 is fixed to the vehicle 100 so as to radiate ultrasonic wave along a rear right direction from a rear right end part of the vehicle 100.

The eighth clearance sonar 308 is fixed to the vehicle 100 so as to radiate ultrasonic wave along the rear direction from the rear end on the right side of the vehicle 100.

The ninth clearance sonar 309 is fixed to the vehicle 100 so as to radiate ultrasonic wave along a left direction from a front left part of the vehicle 100.

The tenth clearance sonar 310 is fixed to the vehicle 100 so as to radiate ultrasonic wave along the left direction from a rear left part of the vehicle 100.

The eleventh clearance sonar 311 is fixed to the vehicle 100 so as to radiate ultrasonic wave along a right direction from a front right part of the vehicle 100.

The twelfth clearance sonar 312 is fixed to the vehicle 100 so as to radiate ultrasonic wave along the right direction from a rear right part of the vehicle 100.

Each of the clearance sonars 313 is configured to receive ultrasonic wave that is reflected from an object.

The sonar sensor device 30 is electrically connected with the ECU 90. The sonar sensor device 30 is configured to transmit, to the ECU 90, information on ultrasonic wave that the clearance sonars 313 radiate and the ultrasonic wave that the clearance sonars 313 receive. The ECU 90 is configured to obtain information on an object present in the vicinity of (or around) the vehicle 100 as “sonar object information”, based on the information sent from the sonar sensor device 30.

In FIG. 2, the direction indicated by a reference Dx is a longitudinal (or front-rear) direction of the vehicle 100, and is referred to as a “vehicle longitudinal direction Dx”, hereinafter. In FIG. 2, the direction indicated by a reference Dy is a lateral (or width) direction of the vehicle 100, and is referred to as a “vehicle width direction Dy”, hereinafter.

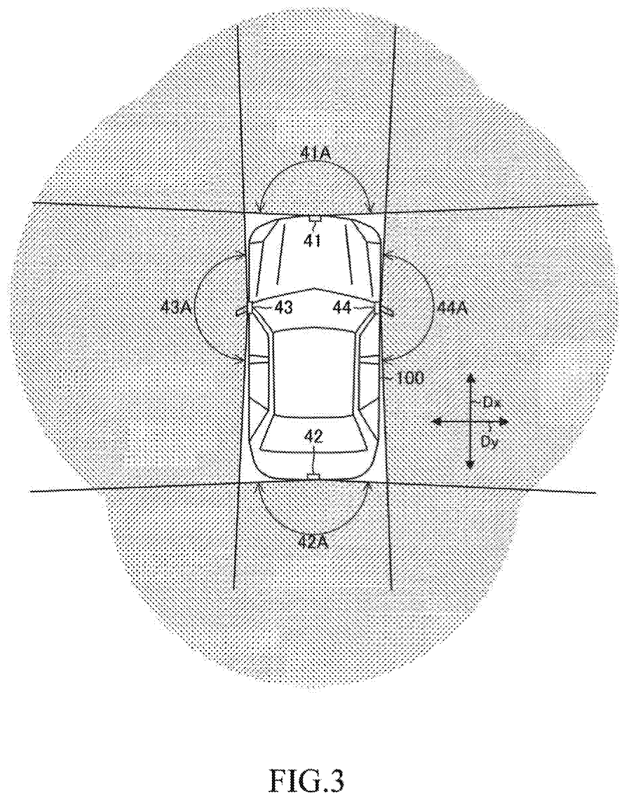

The camera sensor device 40 comprises a front camera 41, a rear camera 42, a left camera 43, and a right camera 44 (refer to FIG. 3). Hereinafter, the front camera 41, the rear camera 42, the left camera 43, and the right camera 44 may sometimes be collectively referred to as “cameras 45”, as appropriate. A group of the cameras 45 may be referred to as “imaging device”.

As shown in FIG. 3, the front camera 41 is fixed to a front end center part of the vehicle 100 so as to photograph (or capture an image of) a scene in front of the vehicle 100. An angle 41A of view of the front camera 41 is about 180 degrees.

The rear camera 42 is fixed to a rear end center part of the vehicle 100 so as to photograph (or capture an image of) a scene behind the vehicle 100. An angle 42A of view of the rear camera 42 is also about 180 degrees.

The left camera 43 is fixed to a left side part of the vehicle 100 so as to photograph (or capture an image of) a scene on the left of the vehicle 100. An angle 43A of view of the left camera 43 is also about 180 degrees.

The right camera 44 is fixed to a right side part of the vehicle 100 so as to photograph (or capture an image of) a scene on the right of the vehicle 100. An angle 44A of view of the right camera 44 is also about 180 degrees.

The camera sensor device 40 is electrically connected with the ECU 90. The ECU 90 is configured to obtain information on the images of the scenes taken by the cameras 45 through the camera sensor device 40.

The information on the image of the scene taken by the front camera 41 may be referred to as “front image information IMG1”, as appropriate.

The information on the image of the scene taken by the rear camera 42 may be referred to as “rear image information IMG2”, as appropriate.

The information on the image of the scene taken by the left camera 43 may be referred to as “left image information IMG3”, as appropriate.

The information on the image of the scene taken by the right camera 44 may be referred to as “right image information IMG4”, as appropriate.

Hereinafter, the front image information IMG1, the rear image information IMG2, the left image information IMG3, and the right image information IMG4 may be collectively referred to as “image information IMG”, as appropriate.

The ECU 90 produces/generates surrounding image information using (or based on) the front image information IMG1, the rear image information IMG2, the left image information IMG3, and the right image information IMG4, every time a predetermined time elapses. A screen displayed (or produced) based on the surrounding image information is referred to as a surrounding image (or image of surroundings of the vehicle 100, surrounding image screen). The surrounding image is an image that corresponds to at least a part of area around the vehicle 100 and includes a camera viewpoint image and synthetic images.

The camera viewpoint image is an image viewed from a position of a lens of each of the cameras 45.

One of the synthetic images is an image of the vicinity of the vehicle 100 viewed from a virtual viewpoint placed at an arbitrary position around the vehicle 100. The image of the vicinity of the vehicle 100 viewed from a virtual viewpoint placed at the arbitrary position around the vehicle 100 is referred to as a “virtual viewpoint image”.

The virtual viewpoint image can be produced based on various well-known methods (refer to Japanese Patent Application Laid-Open (kokai) Nos. 2012-217000, 2016-192772, and 2018-107754). The ECU 90 may produce/generate an image having the camera viewpoint image and/or the virtual viewpoint image. A vehicle image (e.g., a vehicle polygon or a symbolic image) SP representing a shape of the vehicle 100, a figure image including a line or lines for supporting the parking operation, and a character (letter) image including a message for supporting the parking operation are superimposed on the camera viewpoint image and/or the virtual viewpoint image. This type of image may also be referred to as the surrounding image.

One of the methods for producing virtual viewpoint image information from which the virtual viewpoint image is created/produced will be briefly described. The ECU 90 projects “pixels (or picture elements) included in the front image information IMG1, the rear image information IMG2, the left image information IMG3, and the right image information IMG4” onto a predetermined curved projection surface (e.g., a bowl-like surface or a hemispheric dome-like surface) in a virtual three dimensional space (3D space).

A center part of the curved projection surface is regarded as (a location of) the vehicle 100. A part of the curved projection surface other than the center part corresponds to the front image information IMG1, the rear image information IMG2, the left image information IMG3, and the right image information IMG4. The ECU 90 projects “the pixels included in the front image information IMG1, the rear image information IMG2, the left image information IMG3, and the right image information IMG4” onto the part of the curved projection surface other than the center part.

The ECU 90 places the “vehicle polygon representing a shape of the vehicle 100” at the center of the curved projection surface. The ECU 90 sets/places a virtual viewpoint in the virtual 3 dimensional space, and cuts out, as image information (or image), an “area of the curved projection surface” that is a covered/encompassed part of the curved projection surface” within a predetermined view angle from the virtual viewpoint. The ECU 90 superimposes the vehicle polygon representing the shape of the vehicle 100 that is present within the predetermined view angle from the virtual viewpoint on the cut out image information (image). In this manner, the virtual viewpoint image information is produced.

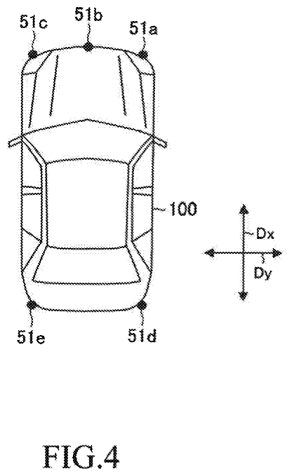

The radar sensor device 50 comprises a first radar sensor 51a to a fifth radar sensor 51e (refer to FIG. 4). Hereinafter, each of the first radar sensor 51a to the fifth radar sensor 51e sometimes be collectively referred to as a “radar sensor 51”, as appropriate.

The radar sensor 51 is a well-known sensor using a millimeter waveband electric wave. The radar sensor 51 is configured to obtain radar sensor object information and transmit the obtained radar sensor object information to the ECU 90. The radar sensor object information is information that can specify a distance between a three dimension object (hereinafter, referred to as a “3D object”) and the vehicle 100, a relative speed between the 3D object and the vehicle 100, a relative position (direction) of the 3D object with respect to the vehicle 100.

As shown in FIG. 4, the radar sensor 51 (51a to 51e) is arranged at a respective position of the vehicle 100 so as to obtain the radar sensor object information on the 3D object present in a respective area, as described below.

The radar sensor 51a is configured to obtain the radar sensor object information on the 3D object that is present in a front right area of the vehicle 100 (an area ahead of the vehicle 100 on the right).

The radar sensor 51b is configured to obtain the radar sensor object information on the 3D object that is present in a front area of the vehicle 100 (an area ahead of the vehicle 100).

The radar sensor 51c is configured to obtain the radar sensor object information on the 3D object that is present in a front left area of the vehicle 100 (an area ahead of the vehicle 100 on the left).

The radar sensor 51d is configured to obtain the radar sensor object information on the 3D object that is present in a rear right area of the vehicle 100 (an area behind the vehicle 100 on the right).

The radar sensor 51e is configured to obtain the radar sensor object information on the 3D object that is present in a rear left area of the vehicle 100 (an area behind the vehicle 100 on the left).

The touch panel display section 60 is arranged at a position of the vehicle 100 so as to be seen by (or be visible to) the user. In the present example, the touch panel display section 60 is a touch panel type display of a so-called navigation system.

The touch panel display section 60 is electrically connected with the ECU 90. The ECU 90 lets/has the touch panel display section 60 display various images (e.g., screen image (hereinafter, simply referred to as a “screen”) including the above described surrounding image).

The parking assist switch 70 is a switch operated (or pressed) by the user.

The camera switch 80 is a switch operated (or pressed) by the user.

### <Outline of Driver Assist Function>

The ECU 90 provides “a driver assist function(s) to assist the driver to drive the vehicle 100” for the vehicle 100. The driver assist function includes at least one of a parking assist function, a panoramic-view monitoring function (hereinafter, referred to as a “PVM function”), and a moving object alert function. In the present embodiment, the driver assist function includes all of the above functions. It should be noted that, when a certain driver assist function is set in an effective state (or is effective), a control corresponding to the certain driver assist function is allowed/permitted to be executed/performed. Whereas, when a certain driver assist function is set in an ineffective state (or is ineffective), a control corresponding to the certain driver assist function is not allowed/permitted to be executed/performed (i.e., the function is prohibited from being executed).

### (Parking Assist Function)

The parking assist function is a function to autonomously or semi-autonomously drive the vehicle 100 to park the vehicle 100 into the parking space or to let the vehicle 100 leave the parking space, so as to assist the driver to drive the vehicle 100 when parking and or leaving. The parking assist function also includes a function to provide the driver with a surrounding monitoring screen including the surrounding image so as to assist the driver to monitor the surroundings of the vehicle 100 when parking the vehicle 100 into the parking space or when letting the vehicle 100 leave the parking space.

The ECU 90 is configured to execute/perform a control to realize/achieve the parking assist function. The control to realize/achieve the parking assist function includes an autonomous parking control and a display control. The autonomous parking control is a control to move the vehicle 100 autonomously from a parking start position to a target parking position in the target parking space, and thereafter, set the vehicle 100 in a parking state. The display control is a control to display the appropriate surrounding monitoring screen on the touch panel display section 60.

### (Panoramic-View Monitoring Function (PVM Function))

The PVM function is a function to display the surrounding monitoring screen that includes the surrounding image (e.g., a bird's-eye-view) on the touch panel display section 60 when the vehicle is running at a low speed (namely, when the vehicle speed SPD is lower than a predetermined low speed threshold SPDLOth), so as to assist the driver to monitor the surroundings of the vehicle. The ECU 90 is configured to execute/perform a control to realize/achieve the PVM function. The control to realize/achieve the PVM function includes a control to display the appropriate surrounding monitoring screen on the touch panel display section 60.

### (Moving Object Alert Function)

The ECU 90 also provides the vehicle 100 with a moving object alert function. The moving object alert function is an alert function (or a warning function) to detect a moving object (e.g., another vehicle, a pedestrian, or the like) that is present around the vehicle 100 based on the radar sensor object information obtained through each radar sensor 51 and camera object information that is information on an object detected/specified based on the captured image (surrounding image) obtained through the cameras 45, and to notify/warn/alert the driver of the moving object when it is detected.

The ECU 90 may display an alert screen including the surrounding image in order to notify/warn the driver of the moving object. The ECU 90 is configured to execute/perform a control to realize/achieve the moving object alert function.

The ECU 90 displays a moving object alert screen as the alert screen on the touch panel display section 60, when a predetermined display condition for the alert screen (i.e., the moving object alert screen) is satisfied. The display condition is satisfied when the moving object is detected based on the radar sensor object information and/or the camera object information. The ECU 90 stops displaying the moving object alert screen on the touch panel display section 60, when a predetermined display end condition for the alert screen (i.e., the moving object alert screen) is satisfied. The display end condition is satisfied when the moving object is no longer detected based on any of the radar sensor object information and the camera object information.

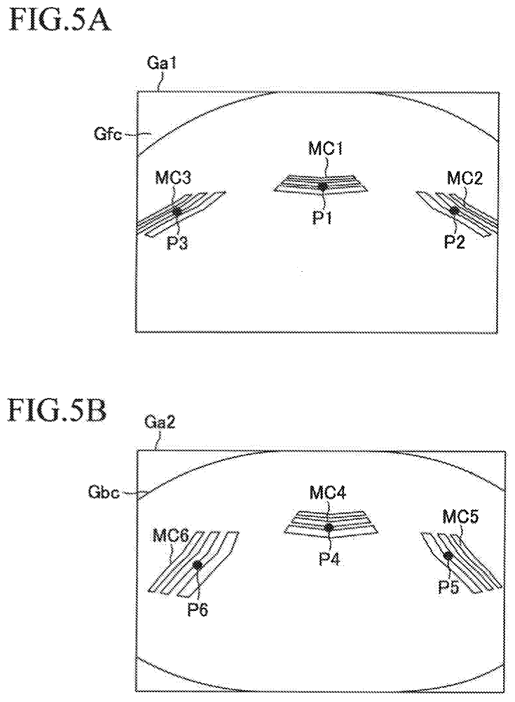

The moving object alert screen includes a first moving object alert image and a second moving object alert image. As the first moving object alert image, there are two kinds of images. One is a front area moving object alert image Ga1 shown in FIG. 5A, and the other is a rear area moving object alert image Ga2 shown in FIG. 5B.

The front area moving object alert image Ga1 shown in FIG. 5A includes a camera viewpoint image Gfc of the front camera 41, a first moving object direction indicator symbol (figure) MC1, a second moving object direction indicator symbol MC2, and a third moving object direction indicator symbol MC3. The direction indicator symbols MC1 to MC3 are displayed so as to be superimposed on the camera viewpoint image Gfc. Each of the direction indicator symbols MC1 to MC3 (and fourth to fourteenth direction indicator symbols MC4-MC14 described later) indicates an approaching direction to the vehicle 100 of the detected moving object. Namely, each of the direction indicator symbols MC1-MC14 indicates a direction (orientation) along which the moving object is coming closer to the vehicle 100. It should be noted that the front area moving object alert image Ga1 may be the camera viewpoint image Gfc on which some figure images (e.g., lines to assist a parking operation) are superimposed (not shown).

The first moving object direction indicator symbol MC1 is placed at a predetermined position P1 which is located at a center of an area ahead of the vehicle 100 in the camera viewpoint image Gfc of the front camera 41.

The second moving object direction indicator symbol MC2 is placed at a predetermined position P2 which is located at a right side of the area ahead of the vehicle 100 in the camera viewpoint image Gfc of the front camera 41.

The third moving object direction indicator symbol MC3 is placed at a predetermined position P3 which is located at a left side of the area ahead of the vehicle 100 in the camera viewpoint image Gfc of the front camera 41.

In the example shown in FIG. 5A, all of the moving object direction indicator symbols MC1 to MC3 are displayed on/in the front area moving object alert image Ga1, however, whether or not each of the symbols MC1 to MC3 is displayed is determined/controlled based on an orientation of the detected moving object with respect to the vehicle 100. Namely, a moving object direction indicator symbol whose orientation coincides with the orientation of the detected moving object that is present in the area ahead of the vehicle 100 is displayed, and a moving object direction indicator symbol whose orientation does not coincide with the orientation of the detected moving object that is present in the area ahead of the vehicle 100 is not displayed.

The rear area moving object alert image Ga2 shown in FIG. 5B includes a camera viewpoint image Gbc of the rear camera 42, a fourth moving object direction indicator symbol MC4, a fifth moving object direction indicator symbol MC5, and a sixth moving object direction indicator symbol MC6. The direction indicator symbols MC4 to MC6 are displayed so as to be superimposed on the camera viewpoint image Gbc. It should be noted that the rear area moving object alert image Ga2 may be the camera viewpoint image Gbc on which some figure images (e.g., lines to assist a parking operation) are superimposed (not shown).

The fourth moving object direction indicator symbol MC4 is placed at a predetermined position P4 which is located at a center of an area behind the vehicle 100 (rear area of the vehicle 100) in the camera viewpoint image Gbc of the rear camera 42.

The fifth moving object direction indicator symbol MC5 is placed at a predetermined position P5 which is located at a right side of the area behind the vehicle 100 in the camera viewpoint image Gbc of the rear camera 42.

The sixth moving object direction indicator symbol MC6 is placed at a predetermined position P6 which is located at a left side of the area behind the vehicle 100 in the camera viewpoint image Gbc of the rear camera 42.

In the example shown in FIG. 5B, all of the moving object direction indicator symbols MC4 to MC6 are displayed on/in the rear area moving object alert image Ga2, however, whether or not each of the symbols MC4 to MC6 is displayed is determined/controlled based on the orientation of the detected moving object that is present in the area behind the vehicle 100 with respect to the vehicle 100. Namely, a moving object direction indicator symbol whose orientation coincides with the orientation of the detected moving object that is present in the area behind the vehicle 100 is displayed, and a moving object direction indicator symbol whose orientation does not coincide with the orientation of the detected moving object that is present in the area behind the vehicle 100 is not displayed.

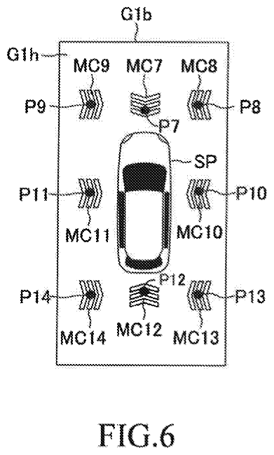

One of examples of the second moving object alert image is a whole around (or an entire surroundings) moving object alert image G1b shown in FIG. 6. The whole around moving object alert image G1b includes the bird's-eye-view G1h; a vehicle polygon/symbol SP, a seventh moving object direction indicator symbol MC7, an eighth moving object direction indicator symbol MC8, a ninth moving object direction indicator symbol MC9, a tenth moving object direction indicator symbol MC10, an eleventh moving object direction indicator symbol MC11, a twelfth moving object direction indicator symbol MC12, a thirteenth moving object direction indicator symbol MC13, and a fourteenth moving object direction indicator symbol MC14. The direction indicator symbols M7 to MC14 are displayed so as to be superimposed on the bird's-eye-view G1h. It should be noted that the whole around moving object alert image G1b may be the bird's-eye-view G1h on which some figure images (e.g., lines to assist a parking operation) are superimposed (not shown).

The seventh moving object direction indicator symbol MC7 is placed at a predetermined position P7 which is located at a center of an area ahead of the vehicle 100 (front area of the vehicle 100) in the bird's-eye-view G1h.

The eighth moving object direction indicator symbol MC8 is placed at a predetermined position P8 which is located at a right side of the area ahead of the vehicle 100 in the bird's-eye-view G1h.

The ninth moving object direction indicator symbol MC9 is placed at a predetermined position P9 which is located at a left side of the area ahead of the vehicle 100 in the bird's-eye-view G1h.

The tenth moving object direction indicator symbol MC10 is placed at a predetermined position P10 which is located on the right side of the vehicle 100 in the bird's-eye-view G1h.

The eleventh moving object direction indicator symbol MC11 is placed at a predetermined position P11 which is located on the left side of the vehicle 100 in the bird's-eye-view G1h.

The twelfth moving object direction indicator symbol MC12 is placed at a predetermined position P12 which is located at a center of an area behind the vehicle 100 (rear area of the vehicle 100) in the bird's-eye-view G1h.

The thirteenth moving object direction indicator symbol MC13 is placed at a predetermined position P13 which is located at a right side of the area behind the vehicle 100 in the bird's-eye-view G1h.

The fourteenth moving object direction indicator symbol MC14 is placed at a predetermined position P14 which is located at a left side of the area behind the vehicle 100 in the bird's-eye-view G1h.

In the example shown in FIG. 6, all of the moving object direction indicator symbols MC7 to MC14 are displayed on/in the whole around moving object alert image G1b, however, whether or not each of the symbols MC7 to MC14 is displayed is determined/controlled based on the orientation of the detected moving object with respect to the vehicle 100. Namely, a moving object direction indicator symbol whose orientation coincides with the orientation of the detected moving object with respect to the vehicle 100 is displayed, and a moving object direction indicator symbol whose orientation does not coincide with the orientation of the detected moving object with respect to the vehicle 100 is not displayed.

### <Outline of Display Control>

### (Parking Assist Display Mode)

When a predetermined operation to the parking assist switch 70 is performed, the ECU 90 sets a display mode to a parking assist display mode. When the display mode is the parking assist display mode, an image appropriate/suitable for assisting the autonomous parking is displayed on the touch panel display section 60.

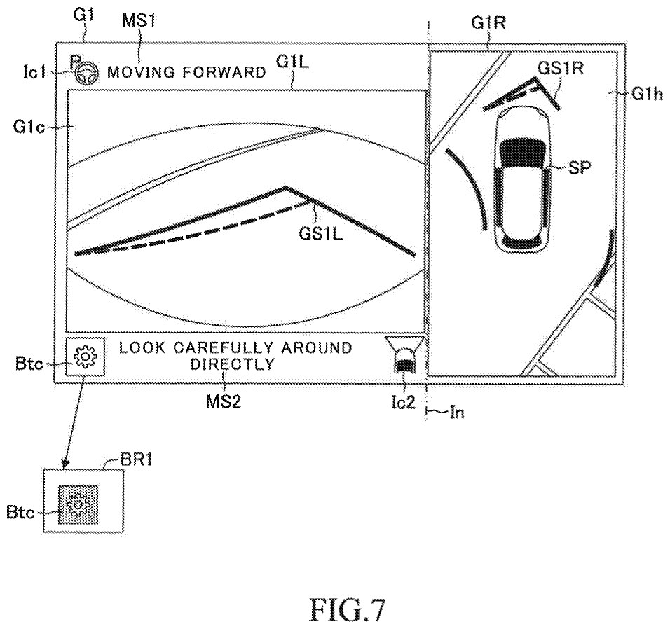

While the display mode is the parking assist display mode, and when the shift position is the “D” or the “N” and the vehicle 100 is moving forward or is in the stopped state (is not moving), the ECU 90 displays, for instance, a parking assist screen G1 shown in FIG. 7 on the touch panel display section 60.

The parking assist screen G1 is divided into a left side area with respect to an imaginary line In and a right side area with respect to the imaginary line In.

The left side area of the parking assist screen G1 includes a left side assist image G1L, a customization button Btc, an icon (image) Ic1, an icon Ic2, a message MS1, and a message MS2.

The left side assist image G1L includes a camera viewpoint image G1c of the front camera 41, and a support figure image GS1L formed of lines that are superimposed on the camera viewpoint image G1c. It should be noted that, as the camera viewpoint image G1c, there are a normal view image and a wide view image. The normal view image is the camera viewpoint image corresponding to a relatively narrow view angle. The wide view image is the camera viewpoint image corresponding to a relatively wide view angle. The camera viewpoint image G1c shown in FIG. 7 is the normal view image corresponding to the camera viewpoint image of the front camera 41.

The customization button Btc is a button formed by an image and touched by the driver (user) in order to display a customization screen. Namely, the customization button Btc displayed on the touch panel display section 60 is operated with the user's touch to the customization button Btc. This operation is referred to a touch operation. The touch operation made/performed to the customization button Btc displayed on the touch panel display section 60 generates an operation signal corresponding to the touch operation. The ECU 90 receives the generated operation signal.

When the vehicle 100 is not in the stopped state (is moving), the ECU 90 sets a working state of the customization button Btc to a state (a disable state/an inoperable state) where the customization button Btc ignores the touch operation to the customization button Btc (or the ECU 90 disables the customization button Btc). In contrast, when the vehicle 100 is in the stopped state (is not moving), the ECU 90 sets the working state of the customization button Btc to a state (an enable state/an operable) where the customization button Btc accepts the touch operation to the customization button Btc (or the ECU 90 enables the customization button Btc).

The ECU 90 displays the customization button Btc in either a first display mode or a second display mode according to the working state of the customization button Btc. Specifically, the ECU 90 displays the customization button Btc in the first display mode when the working state of the customization button Btc is the enable state where the customization button Btc accepts the touch operation to the customization button Btc. Whereas, the ECU 90 displays the customization button Btc in the second display mode when the working state of the customization button Btc is the disable state where the customization button Btc ignores (does not accept) the touch operation to the customization button Btc.

In the example shown in FIG. 7, since the vehicle 100 is moving (i.e., is not in the stopped state), the customization button Btc is displayed in the second display mode. In the example, the button Btc is darkly displayed when it is displayed in the second display mode. Thus, in the parking assist screen G1 shown in FIG. 7, the customization button Btc is in the disable state where the button Btc does not accept (response to) the touch operation.

When the vehicle 100 is in the stopped state, the ECU 90 sets the customization button Btc to the enable state where the button Btc can accept the touch operation to the button Btc, and displays the button Btc in the first display mode in place of the second display mode. The customization button Btc displayed in the first display mode is shown in a block BR1. In the example, the button Btc is brightly displayed when it is displayed in the first display mode.

The icon Ic1 is displayed so as to indicate an operation state of the parking assist function. Specifically, the ECU 90 displays the icon Ic1 when the parking assist function is the effective state, and does not display the icon Ic1 when the parking assist function is not in the effective state. The icon Ic2, that is also displayed by the ECU 90, indicates what camera corresponds to the camera viewpoint image G1c (i.e., which camera is providing the camera viewpoint image G1c, the front camera 41 or the rear camera 42), and also indicates whether the camera viewpoint image G1c is the normal view image or the wide view image.

The message MS1 and the message MS2, displayed by the ECU 90, are messages to notify the driver (or the user) of a moving direction of the vehicle 100 and to assist the driver to monitor the surroundings of the vehicle 100. The support figure image GS1L is displayed by the ECU 90, for instance, so as to assist the driver to monitor the surroundings of the vehicle 100.

The right side area of the parking assist screen G1 includes a right side assist image G1R. The right side assist image G1R includes a bird's-eye-view G1h, a support figure image GS1R formed of lines that are superimposed on the bird's-eye-view G1h, and a vehicle polygon/symbol SP. The support figure image GS1R is displayed by the ECU 90, for instance, so as to assist the driver to monitor the surroundings of the vehicle 100, similarly to the support figure image GS1L.

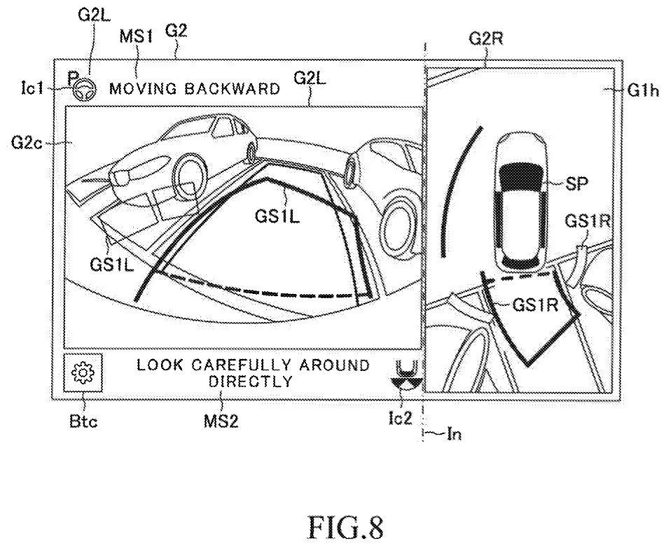

While the display mode is the parking assist display mode, and when the shift position is the “R” and the vehicle 100 is moving backward or is in the stopped state (is not moving), the ECU 90 displays, for instance, a parking assist screen G2 shown in FIG. 8 on the touch panel display section 60.

The left side area of the parking assist screen G2 includes a left side assist image G2L, the customization button Btc, the icon Ic1, the icon Ic2, the message MS1, and the message MS2.

The left side assist image G2L includes a camera viewpoint image G2c of the rear camera 42, and a support figure image GS1L formed of lines that are superimposed on the camera viewpoint image G2c. It should be noted that the camera viewpoint image G2c is the normal view image corresponding to the camera viewpoint image of the rear camera 42.

The right side area of the parking assist screen G2 includes a right side assist image G2R. The right side assist image G2R includes a bird's-eye-view G1h, a support figure image GS1R formed of lines that are superimposed on the bird's-eye-view G1h, and a vehicle polygon/symbol SP.

### <Outline of Operation Regarding Parking Assist Function>

For instance, it is assumed that the vehicle 100 is in the stopped state due to the brake operation by the driver, when the shift position is the “D” or the “N” in the case where the display mode is the parking assist display mode. It is further assumed that the moving object alert function is effective (enabled, active).

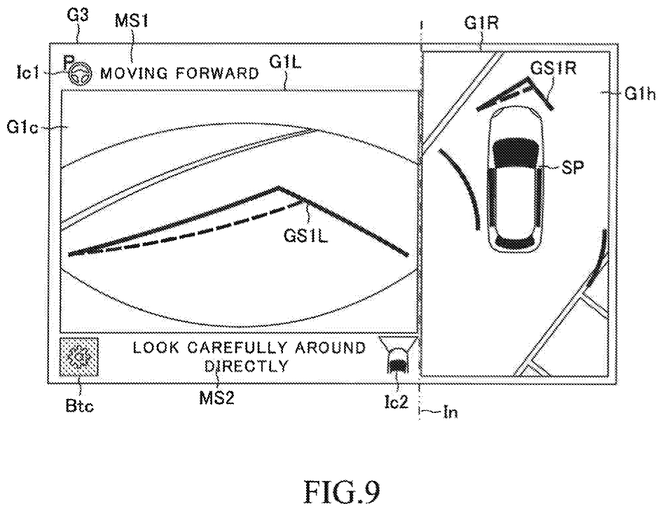

In the assumption described above, for instance, the parking assist screen G3 shown in FIG. 9 is displayed. The parking assist screen G3 shown in FIG. 9 is different from the parking assist screen G1 shown in FIG. 7 only in that the customization button Btc in the screen G3 is displayed in the first display mode.

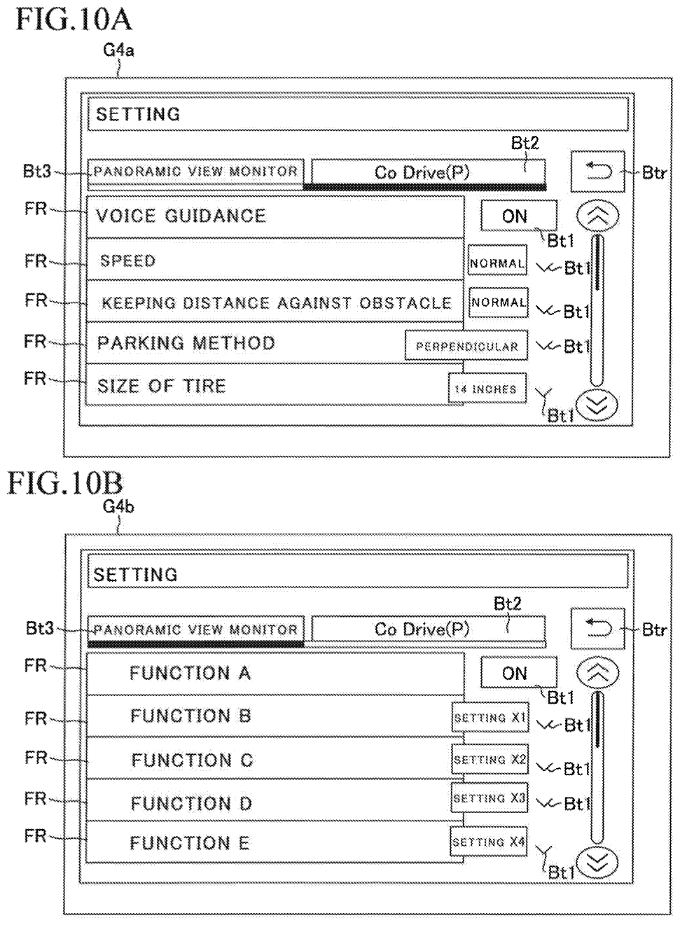

When the customization button Btc in the parking assist screen G3 is touched, the ECU 90 stops displaying the parking assist screen G3 on the touch panel display section 60, and instead, starts displaying a customization screen G4a shown in FIG. 10A on the touch panel display section 60.

The customization screen G4a is an operation screen that allows the driver/user to operate in order to change/set various operation states (or setting states or operation conditions) of the parking assist function.

The customization screen G4a includes:
a name of function, whose operation state can be changed, and that is displayed in each of a plurality of fames FR;
function changing/setting buttons Bt1;
screen changing buttons Bt2, Bt3; and
a return button Btr.

Each of the function changing/setting buttons Bt1 is a button to which the touch operation is made so as to change the operation state. The operation state may include setting value (parameter) used in the function.

Each of the screen changing buttons Bt2 and Bt3 is a button to which the touch operation is made so as to change the displayed screen from the customization screen G4a to one of other customization screens.

It should be noted that the customization screen G4a shown in FIG. 10B is an operation screen that is used by the driver/user to change the operation states of the PVM function. When the screen changing button Bt3 of the customization screen G4a shown in FIG. 10A is touched, the ECU 90 stops displaying the customization screen G4a, and instead, starts displaying the customization screen G4b shown in FIG. 10B.

When the customization screen G4a shown in FIG. 10A is being displayed on the touch panel display section 60, it is assumed that the alert function (in the present example, the moving object alert function) is effective. It is further assumed that a moving object approaching the vehicle 100 from the front right side of the vehicle 100 is detected so that the display condition for the moving object alert screen becomes satisfied.

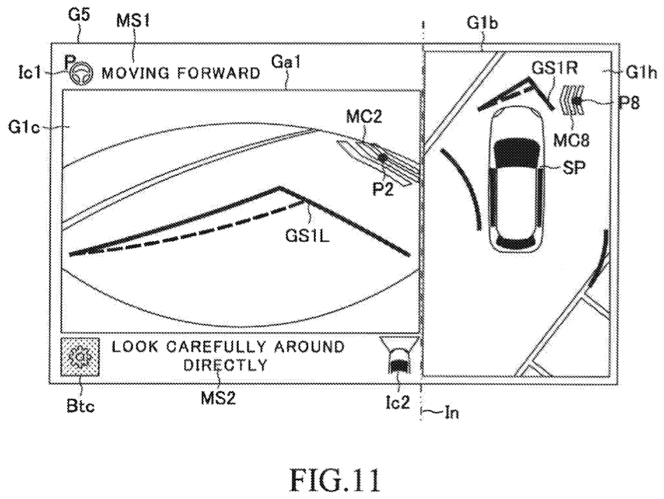

In this case, the ECU 90 stops displaying the customization screen G4a, and instead, starts displaying the moving object alert screen G5 shown in FIG. 11 on the touch panel display section 60.

The left side area of the moving object alert screen G5 includes the front area moving object alert image Gal, the customization button Btc, the icon Ic1, the icon Ic2, the message MS1, and the message MS2.

The front area moving object alert image Ga1 includes the camera viewpoint image G1c of the front camera 41, the support figure image GS1L superimposed on the camera viewpoint image G1c, and the second moving object direction indicator symbol MC2. It should be noted that the camera viewpoint image G1c may be replaced with the wide view image corresponding to the camera viewpoint image of the front camera 41. The second moving object direction indicator symbol MC2 is located/placed at a predetermined position around the vehicle 100 in the camera viewpoint image G1c, the orientation of the predetermined position with respect to the vehicle 100 coinciding with the orientation of the detected object (that is approaching the vehicle 100) with respect to the vehicle 100. Specifically, the second moving object direction indicator symbol MC2 is superimposed on the position P2 which is located at the right side of the area ahead of the vehicle 100 and whose orientation coincides with the orientation of the moving object that is present in the right side of the area ahead of the vehicle 100.

The right side area of the moving object alert screen G5 includes the whole around moving object alert image G1b. The whole around moving object alert image G1b includes the bird's-eye-view G1h, the support figure image GS1R superimposed on the bird's-eye-view G1h, the eighth moving object direction indicator symbol MC8, and the vehicle polygon/symbol SP. The eighth moving object direction indicator symbol MC8 is located/placed at a predetermined position around the vehicle 100 in the bird's-eye-view G1h, the orientation of the predetermined position with respect to the vehicle 100 coinciding with the orientation of the detected object with respect to the vehicle 100. Specifically, the eighth moving object direction indicator symbol MC8 is superimposed on the position P8 which is located at the right side of the area ahead of the vehicle 100 and whose orientation coincides with the orientation of the moving object that is present in the right side of the area ahead of the vehicle 100.

Thereafter, when the display end condition for the moving object alert screen G5 becomes satisfied, the ECU 90 stops displaying the moving object alert screen G5 shown in FIG. 11 that has been displayed on the touch panel display section 60, and instead, starts displaying the customization screen G4a shown in FIG. 10A on the touch panel display section 60 again.

It should be noted that, when the return button Btr in the customization screen G4a that is being displayed on the touch panel display section 60 is touched so that the display end condition for the customization screen G4a becomes satisfied, the ECU 90 stops displaying the customization screen G4a that has been displayed on the touch panel display section 60, and instead, starts displaying the parking assist screen G3 shown in FIG. 9 on the touch panel display section 60.

### (PVM Display Mode)

When the camera switch 80 is operated while the vehicle 100 is in a predetermined state, the ECU 90 sets the display mode to a PVM display mode. When the display mode is the PVM display mode, an image appropriate/suitable for the PVM function is displayed on the touch panel display section 60.

More specifically, while the display mode is the PVM display mode, the ECU 90 displays, on the touch panel display section 60, a surrounding monitoring screen (hereinafter, referred to as a “PVM screen”) that varies based on the shift position of when the camera switch 80 is operated. The PVM screen includes a predetermined surrounding image. For instance, the PVM screen includes one of a synthetic image and the bird's-eye-view, as well as the camera viewpoint image. The synthetic image is an image of the surrounding area of the vehicle 100 viewed from a virtual viewpoint obliquely positioned above the vehicle 100.

In addition, when an unillustrated screen change switch included in the PVM screen is touched, the ECU 90 switches between one of the PVM screens (e.g. the PVM screen having the bird's-eye-view and the camera viewpoint image) and another of the PVM screens (e.g. the PVM screen having the camera viewpoint image of the left camera 43 and the camera viewpoint image of the right camera 44).

### <Outline of Operation Regarding PVM Function>

For instance, it is assumed that the vehicle 100 is in the stopped state due to the brake operation by the driver, when the shift position is the “D” or the “N” in the case where the display mode is the PVM display mode.

In this case, the ECU 90 displays the unillustrated PVM screen (the screen having the bird's-eye-view and the camera viewpoint image) that includes the customization button Btc on the touch panel display section 60 similarly to when the mode is the above described parking assist display mode. When the customization button Btc in the PVM screen is touched, the ECU 90 stops displaying the PVM screen that has been displayed on the touch panel display section 60, and instead, starts displaying the customization screen G4b shown in FIG. 10B on the touch panel display section 60.

While the ECU 90 is displaying the customization screen G4b on the touch panel display section 60 and the alert function (in the present example, the moving object alert function) is effective, the ECU 90 stops displaying the customization screen G4b, and instead, starts displaying the moving object alert screen on the touch panel display section 60, when the display condition for the alert screen (i.e., the moving object alert screen) becomes satisfied.

Thereafter, when the display end condition for the moving object alert screen becomes satisfied, the ECU 90 stops displaying the moving object alert screen, and instead, starts displaying the customization screen G4b on the touch panel display section 60 again.

It should be noted that, when the return button Btr in the customization screen G4b that is being displayed on the touch panel display section 60 is touched so that the display end condition for the customization screen becomes satisfied, the ECU 90 stops displaying the customization screen G4b that has been displayed on the touch panel display section 60, and instead, starts displaying the PVM screen on the touch panel display section 60.

### <Specific Operation>

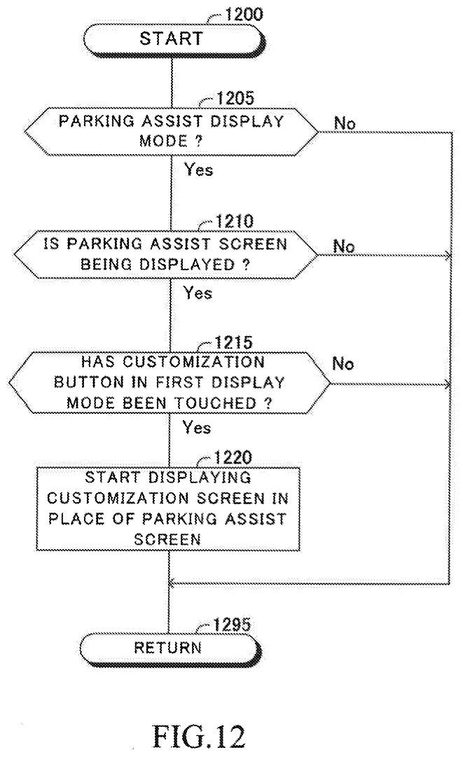

The CPU (hereinafter, simply referred to as the “CPU”) of the ECU 90 is configured to execute a routine shown by a flowchart in FIG. 12, every time a predetermined time elapses.

Thus, at an appropriate timing, the CPU starts process of step 1200 shown in FIG. 12, and proceeds to step 1205 to determine whether or not the display mode is the parking assist display mode.

When the display mode is not the parking assist display mode, the CPU makes a “No” determination at step 1205, and proceeds to step 1295 to terminate the present routine tentatively.

In contrast, when the display mode is the parking assist display mode, the CPU makes a “Yes” determination at step 1205 to proceed to step 1210, at which the CPU determines whether or not the CPU is displaying the parking assist screen on the touch panel display section 60.

When the CPU is not displaying the parking assist screen on the touch panel display section 60, the CPU makes a “No” determination at step 1210, and proceeds to step 1295 to terminate the present routine tentatively.

Whereas, when the CPU is displaying the parking assist screen on the touch panel display section 60, the CPU makes a “Yes” determination at step 1210, and proceeds to step 1215 to determine whether or not the customization button Btc displayed in the first display mode (i.e., the customization button Btc that is in the enable state) has just been touched.

If it is not determined that the customization button Btc has just been touched, the CPU makes a “No” determination at step 1215, and proceeds to step 1295 to terminate the present routine tentatively.

In contrast, if it is determined that the customization button Btc has just been touched, the CPU makes a “Yes” determination at step 1215. Thereafter, the CPU proceeds to the process of step 1220 described below, and proceeds to step 1295 to terminate the present routine tentatively.

Step 1220: the CPU stops displaying the parking assist screen, and starts displaying the customization screen G4a on the touch panel display section 60.

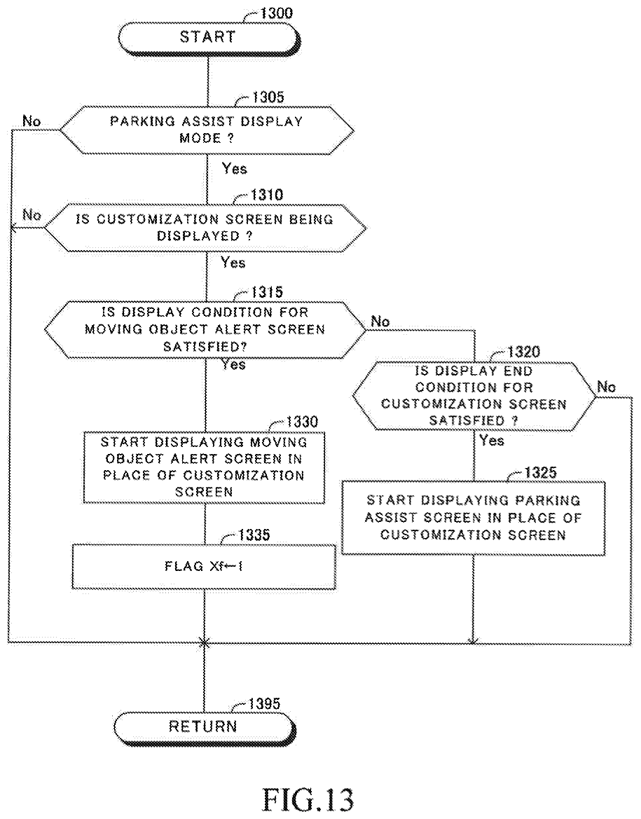

Meanwhile, the CPU is configured to execute a routine shown by a flowchart in FIG. 13, every time a predetermined time elapses. Thus, at an appropriate timing, the CPU starts process of step 1300 shown in FIG. 13, and proceeds to step 1305 to determine whether or not the display mode is the parking assist display mode.

When the display mode is not the parking assist display mode, the CPU makes a “No” determination at step 1305, and proceeds to step 1395 to terminate the present routine tentatively. In contrast, when the display mode is the parking assist display mode, the CPU makes a “Yes” determination at step 1305 to proceed to step 1310, at which the CPU determines whether or not the CPU is displaying the customization screen G4a on the touch panel display section 60.

When the CPU is not displaying the customization screen G4a on the touch panel display section 60, the CPU makes a “No” determination at step 1310, and proceeds to step 1395 to terminate the present routine tentatively.

Whereas, when the CPU is displaying the customization screen G4a on the touch panel display section 60, the CPU makes a “Yes” determination at step 1310, and proceeds to step 1315 to determine whether or not the display condition for the moving object alert screen (i.e., the display condition for the alert screen) is satisfied.

When the display condition for the moving object alert screen is not satisfied, the CPU makes a “No” determination at step 1315, and proceeds to step 1320 to determine whether or not the display end condition for the customization screen G4a is satisfied.

If the display end condition for the customization screen G4a is not satisfied, the CPU makes a “No” determination at step 1320, and proceeds to step 1395 to terminate the present routine tentatively.

In contrast, if the display end condition for the customization screen G4a is satisfied, the CPU proceeds to the process of step 1325 described below, and proceeds to step 1395 to terminate the present routine tentatively.

Step 1325: the CPU stops displaying the customization screen G4a, and starts displaying the parking assist screen on the touch panel display section 60.

Meanwhile, when the CPU proceeds to step 1315 and the display condition for the moving object alert screen is satisfied, the CPU makes a “Yes” determination at step 1315. Then, the CPU executes the processes of step 1330 and step 1335, described below, and proceeds to step 1395 to terminate the present routine tentatively.

Step 1330: the CPU stops displaying the customization screen G4a, and starts displaying the moving object alert screen on the touch panel display section 60.

Step 1335: the CPU sets a value of a flag Xf to “1”. The value of the flag Xf is set to “0” through an initialization routine executed by the CPU when an unillustrated ignition key switch of the vehicle 100 is changed from an off position to an on position. In addition, the value of the flag Xf is set to “0” through a process of step 1425 described later. The value of the flag Xf indicates that the customization screen G4a has been replaced with the moving object alert screen (when the value is “1”).

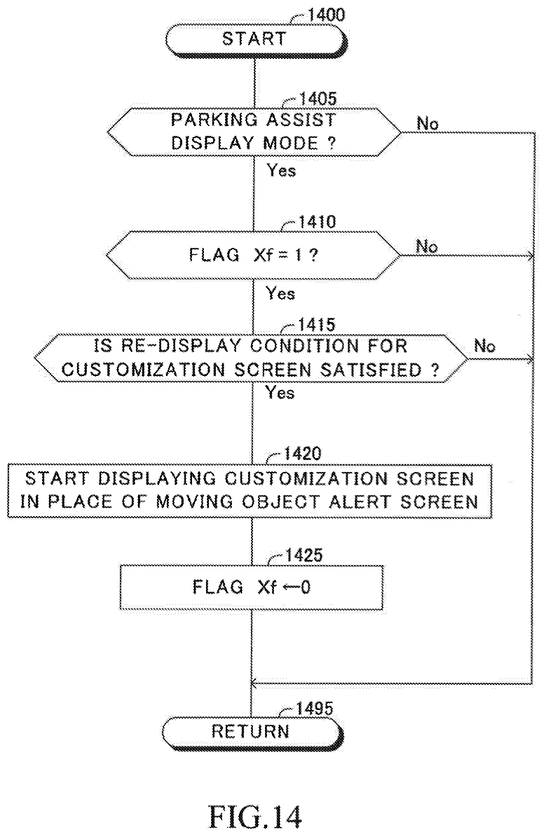

Furthermore, the CPU is configured to execute a routine shown by a flowchart in FIG. 14, every time a predetermined time elapses. Thus, at an appropriate timing, the CPU starts process of step 1400 shown in FIG. 14, and proceeds to step 1405 to determine whether or not the display mode is the parking assist display mode.

When the display mode is not the parking assist display mode, the CPU makes a “No” determination at step 1405, and proceeds to step 1495 to terminate the present routine tentatively.

In contrast, when the display mode is the parking assist display mode, the CPU makes a “Yes” determination at step 1405 to proceed to step 1410, at which the CPU determines whether or not the value of the flag Xf is “1”.

If the value of the flag Xf is not “1”, the CPU makes a “No” determination at step 1410, and proceeds to step 1495 to terminate the present routine tentatively.

In contrast, if the value of the flag Xf is “1”, the CPU makes a “Yes” determination at step 1410, and proceeds to step 1415 to determine whether or not a re-display condition for the customization screen G4a is satisfied. For instance, the re-display condition for the customization screen G4a becomes satisfied, when the display end condition for the moving object alert screen becomes satisfied.

When the re-display condition for the customization screen G4a is not satisfied, the CPU makes a “No” determination at step 1415, and proceeds to step 1495 to terminate the present routine tentatively.

Whereas, when the re-display condition for the customization screen G4a is satisfied, the CPU makes a “Yes” determination at step 1415, and executes the processes of step 1420 and step 1425, described below. Thereafter, the CPU proceeds to step 1495 to terminate the present routine tentatively.

Step 1420: the CPU stops displaying the moving object alert screen, and starts displaying the customization screen G4a on the touch panel display section 60. At this time, the customization screen G4a started to be displayed is the same as the (last) customization screen G4a of the time point immediately before it was replaced with the moving object alert screen.

This allows the user (or the driver) to operate/use the customization screen G4a that is the same as the customization screen G4a of the time point immediately before it was replaced with the moving object alert screen, when and after the customization screen G4a started to be displayed at step 1420. Therefore, the CPU can ensure the ease of use with respect to the customization screen G4a.

Step 1425: the CPU sets the value of the flag Xf to “0”.

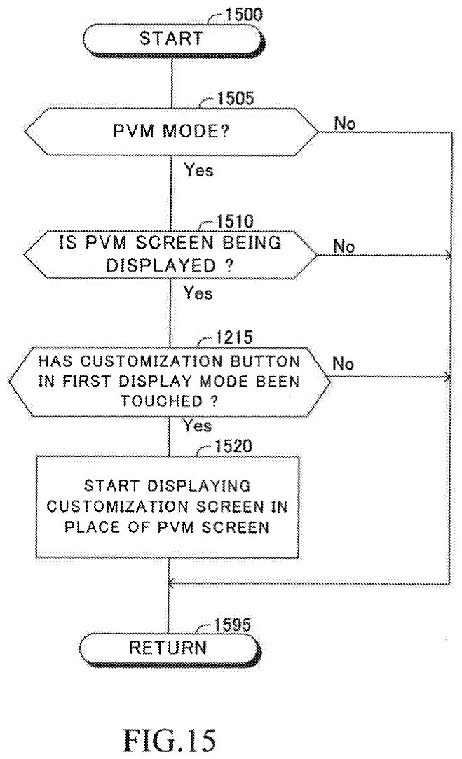

The CPU is configured to execute a routine shown by a flowchart in FIG. 15, every time a predetermined time elapses. The routine shown in FIG. 15 is different from the routine shown in FIG. 12 only in the following points.

Step 1205 shown in FIG. 12 is replaced with step 1505. More specifically, the CPU determines whether or not the display mode is the PVM mode at step 1505, in place of determining whether or not the display mode is the parking assist display mode at step 1205.

Step 1210 shown in FIG. 12 is replaced with step 1510. More specifically, the CPU determines whether or not the CPU is displaying the PVM screen at step 1510, in place of determining whether or not the CPU is displaying the parking assist screen at step 1210.

Step 1220 shown in FIG. 12 is replaced with step 1520. More specifically, the CPU stops displaying the PVM screen, and starts displaying the customization screen G4a on the touch panel display section 60 at step 1520.

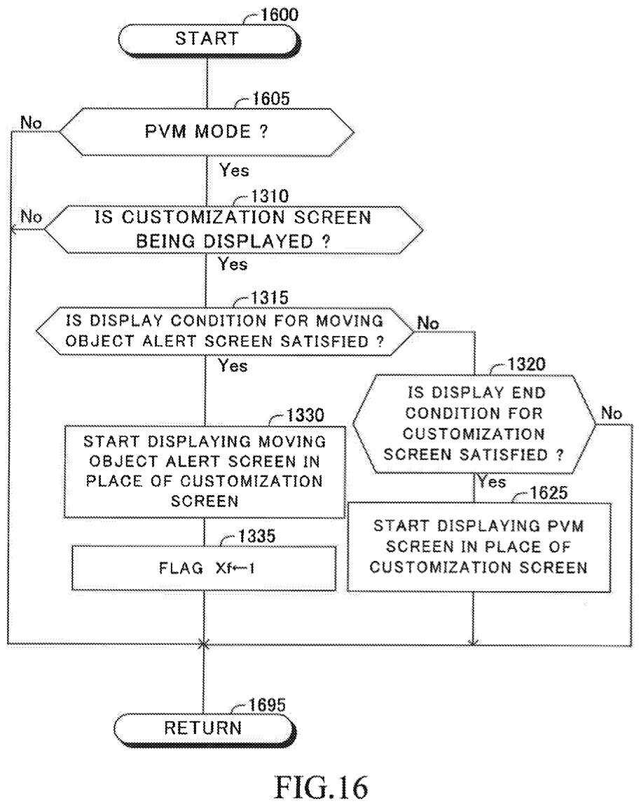

The CPU is configured to execute a routine shown by a flowchart in FIG. 16, every time a predetermined time elapses. The routine shown in FIG. 16 is different from the routine shown in FIG. 13 only in the following points.

Step 1305 shown in FIG. 13 is replaced with step 1605. More specifically, the CPU determines whether or not the display mode is the PVM mode at step 1605, in place of determining whether or not the display mode is the parking assist display mode at step 1305.

Step 1325 shown in FIG. 13 is replaced with step 1625. More specifically, the CPU stops displaying the customization screen, and instead, starts displaying the PVM screen on the touch panel display section 60 at step 1625.

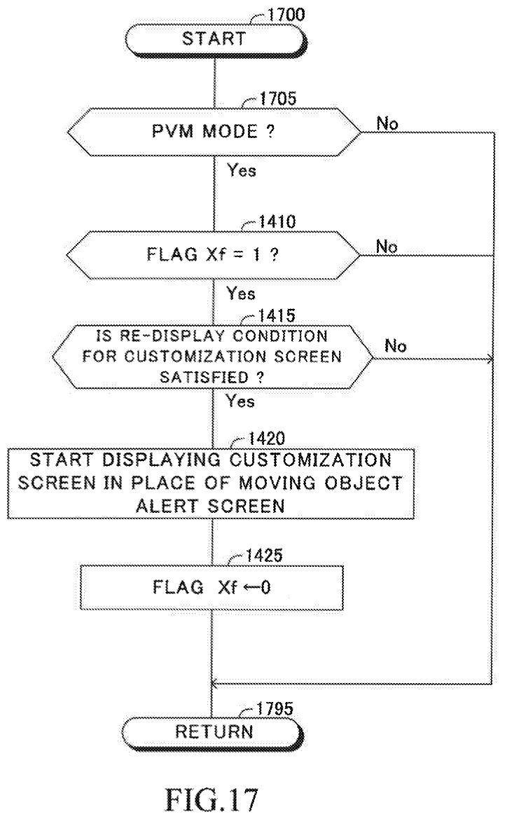

The CPU is configured to execute a routine shown by a flowchart in FIG. 17, every time a predetermined time elapses. The routine shown in FIG. 17 is different from the routine shown in FIG. 14 only in the following point.

Step 1405 shown in FIG. 14 is replaced with step 1705. More specifically, the CPU determines whether or not the display mode is the PVM mode at step 1705, in place of determining whether or not the display mode is the parking assist display mode at step 1405.

As has been described above, the driver assist apparatus 10 of the embodiment according to the present disclosure is configured to start displaying the moving object alert screen that includes the surrounding image, in place of the customization screen, when the predetermined condition becomes satisfied due to the detection of the moving object coming closer to the vehicle 100 while the driver assist apparatus 10 has been displaying the customization screen. Accordingly, the driver assist apparatus 10 can decrease the possibility that the ability of assisting the driver to monitor the surroundings of the vehicle 100 is degraded.

### MODIFIED EXAMPLES

The present disclosure is not limited to the above embodiment, and can employ various modifications within the scope of the present disclosure.

For example, the ECU 90 may be configured to provide the vehicle 100 with, in addition to or in place of the moving object alert function, at least one of functions described below as the above described alert function.

### (Clearance Sonar Function)

The clearance sonar function is a function to detect a distance between the vehicle 100 and a stationary object using the sonar sensor device 30 including the clearance sonars 313, and to issue an alert to the driver of the vehicle 100 when the sonar sensor device 30 detects a stationary object (hereinafter, referred to as a “close stationary object”) having the distance shorter than a predetermined distance threshold. The ECU 90 may be configured to perform a control to achieve the clearance sonar function.

The ECU 90 determines that a display condition for a clearance alert screen is satisfied when the sonar sensor device 30 detects the close stationary object. The ECU 90 displays the clearance alert screen to notify the driver of the close stationary object on the touch panel display section 60 when the display condition for the clearance alert screen is determined to be satisfied. The ECU 90 determines that a display end condition for the clearance alert screen is satisfied, when the sonar sensor device 30 no longer detects the close stationary object. The ECU 90 stops/ends displaying the clearance alert screen that has been displayed on the touch panel display section 60, when the display end condition for the clearance alert screen is determined to be satisfied.

### (Front Cross Traffic Alert Function)

The front cross traffic alert function is referred to as an “FCTA function”, and is a function to:
detect another vehicle (hereinafter, referred to as a “front lateral approaching other vehicle”) approaching the front end of the vehicle 100 from the right side or the left side of the vehicle 100, based on the radar sensor object information acquired by the radar sensor 51a arranged at the front end on the right side of the vehicle 100 and by the radar sensor 51c arranged at the front end on the left side of the vehicle 100; and
issue an alert to the driver of the vehicle 100 when the front lateral approaching other vehicle is detected.

The ECU 90 may be configured to perform a control to achieve the FCTA function.

The ECU 90 determines that a display condition for an FCTA screen is satisfied when at least one of the radar sensor 51a and the radar sensor 51c has detected the front lateral approaching other vehicle. The ECU 90 displays, on the touch panel display section 60, the FCTA screen so as to notify/alert the driver of the front lateral approaching other vehicle when the display condition for the FCTA screen is determined to be satisfied. The ECU 90 determines that a display end condition for the FCTA screen is satisfied, when neither the radar sensor 51a nor the radar sensor 51c detects the front lateral approaching other vehicle any longer. The ECU 90 stops/ends displaying the FCTA screen that has been displayed on the touch panel display section 60, when the display end condition for the FCTA screen is determined to be satisfied.

### (Rear Cross Traffic Alert Function)

The rear cross traffic alert function is referred to as an “RCTA function”, and is a function to:
detect another vehicle (hereinafter, referred to as a “rear lateral approaching other vehicle”) approaching the rear end of the vehicle 100 from the right side or the left side of the vehicle 100, based on the radar sensor object information acquired by the radar sensor 51d arranged at the rear end on the right side of the vehicle 100 and by the radar sensor 51e arranged at the rear end on the left side of the vehicle 100; and
issue an alert to the driver of the vehicle 100 when the rear lateral approaching other vehicle is detected.

The ECU 90 may be configured to perform a control to achieve the RCTA function.

The ECU 90 determines that a display condition for an RCTA screen is satisfied when at least one of the radar sensor 51d and the radar sensor 51e has detected the rear lateral approaching other vehicle. The ECU 90 displays, on the touch panel display section 60, the RCTA screen so as to notify/alert the driver of the rear lateral approaching other vehicle when the display condition for the ROTA screen is determined to be satisfied. The ECU 90 determines that a display end condition for the ROTA screen is satisfied, when neither the radar sensor 51d nor the radar sensor 51e detects the rear lateral approaching other vehicle any longer. The ECU 90 stops/ends displaying the ROTA screen that has been displayed on the touch panel display section 60, when the display end condition for the ROTA screen is determined to be satisfied.

### (Rear Camera Detection Function)

The rear camera detection function is referred to as an “RCD function”, and is a function to:
detect a pedestrian (hereinafter, referred to as a “rear area pedestrian”) present in a predetermined area behind the vehicle 100, based on the camera object information acquired by the rear camera 42; and
issue an alert to the driver of the vehicle 100 when the rear area pedestrian is detected.

The ECU 90 may be configured to perform a control to achieve the RCD function.

The ECU 90 determines that a display condition for an RCD alert screen is satisfied when the rear camera 42 has detected the rear area pedestrian. The ECU 90 displays, on the touch panel display section 60, the RCD alert screen so as to notify/alert the driver of the rear area pedestrian when the display condition for the RCD alert screen is determined to be satisfied. The ECU 90 determines that a display end condition for the RCD alert screen is satisfied, when the rear camera 42 no longer detects the rear area pedestrian. The ECU 90 stops/ends displaying the RCD alert screen that has been displayed on the touch panel display section 60, when the display end condition for the RCD alert screen is determined to be satisfied.

When one of the above described alert functions is effective, the one of the above described alert functions operates in the same manner as the moving object alert function of the above-described embodiment. Specifically, when the ECU 90 determines that the display condition for one of the above described alert screens becomes satisfied while the ECU 90 has been displaying the customization screen, the ECU 90 stops displaying the customization screen on the touch panel display section 60, and instead, starts displaying one of the above described alert screens on the touch panel display section 60. When the ECU 90 determines that the display end condition for one of the above described alert screens becomes satisfied while the ECU 90 has been displaying the one of the above described alert screens that has been displayed in place of the customization screen, the ECU 90 stops displaying the one of the above described alert screens on the touch panel display section 60, and instead, starts displaying the customization screen on the touch panel display section 60.

In some embodiments, the customization button Btc may be a physical/mechanical button (that is not the button displayed on the touch panel display section 60). In this case, neither the parking assist screen nor the PVM screen may include the customization button Btc. Further in this case, the touch panel display section 60 may be replaced with a display other than the touch panel type display.

What is claimed is:

1. A driver assist apparatus installed on a vehicle, comprising:
a surrounding monitor sensor device configured to capture an image of a surrounding area of said vehicle so as to obtain image information and object information regarding an object that is present around said vehicle;
a touch panel configured to be capable of displaying images; and
a control unit configured to be capable of changing said images displayed on said touch panel,
wherein,
said control unit is configured to:
display, on said touch panel, a surrounding monitoring screen that includes a surrounding image of said surrounding area of said vehicle when a predetermined surrounding monitoring screen display condition is satisfied, said surrounding image being generated based on said image information;
display, on said touch panel, a customization screen in place of said surrounding monitoring screen when an operation to a customization button is detected while said surrounding monitoring screen is being displayed, said customization screen being a screen that is operated to change operation conditions of driving assist functions that said control unit provides for said vehicle; and
display, on said touch panel, an alert screen including said surrounding image and an alert image for notifying a driver of said vehicle of a presence of a target alert object that is said object that said driver should pay attention to, in place of said customization screen, if said target alert object is detected based on said object information even when said customization screen is being displayed in place of said surrounding monitoring screen.

2. The driver assist apparatus according to claim 1,
wherein,
said control unit is configured to display, on said touch panel, said customization screen in place of said alert screen when said target alert object is no longer detected while said alert screen is being displayed in place of said customization screen.

3. The driver assist apparatus according to claim 1,
wherein,
said control unit is configured to:
display said surrounding monitoring screen in such a manner that said surrounding monitoring screen includes said customization button;
detect a touch operation to said customization button as said operation to said customization button, when said vehicle is in a stopped state; and
ignore said touch operation to said customization button so as not to detect said touch operation as said operation to said customization button, when said vehicle is not in said stopped state.

4. The driver assist apparatus according to claim 1,
wherein,
said control unit is configured to, when a moving object approaching said vehicle is detected as said target alert object, display said alert screen in such a manner that a figure indicating a direction along which said moving object is coming closer to said vehicle.

5. The driver assist apparatus according to claim 1,
wherein,
said control unit is configured to:
provide said vehicle with, as one of said driving assist functions, a parking assist function to assist said driver to park said vehicle;
display, as said surrounding monitoring screen, a parking assist screen to assist said driver to park said vehicle; and
display, as said customization screen, a screen to change operation states of said parking assist function.

6. The driver assist apparatus according to claim 1,
wherein,
said control unit is configured to:
provide said vehicle with, as one of said driving assist functions, a panoramic-view monitoring function to display, as said surrounding monitoring screen, a panoramic-view monitor screen including a bird's-eye-view of said vehicle, when a speed of said vehicle is equal to or lower than a predetermined speed threshold; and
display, as said customization screen, a screen to change operation states of said panoramic-view monitoring function.
